(19) United States
(12) Patent Application Publication
(10) Pub. No.: US 2024/0023064 A1
(43) Pub. Date: Jan. 18, 2024

(54) PAGING EARLY INDICATION IN SHARED SPECTRUM

(71) Applicant: QUALCOMM Incorporated, San Diego, CA (US)

(72) Inventors: Ozcan Ozturk, San Diego, CA (US); Xiaoxia Zhang, San Diego, CA (US); Huilin Xu, Temecula, CA (US)

(21) Appl. No.: 17/867,438

(22) Filed: Jul. 18, 2022

(51) Int. Cl. H04W 68/02; H04W 52/02; H04W 16/14; H04W 74/08

(52) U.S. Cl. CPC H04W 68/02; H04W 52/0216; H04W 52/0229; H04W 16/14; H04W 74/0808

(57) ABSTRACT

Methods, systems, and devices for wireless communications are described. A user equipment (UE) may operate in an idle mode in which the UE does not actively monitor for incoming transmissions. In some cases, the network may probe the idle UE by sending a paging early indication (PEI), which may trigger the UE to monitor paging occasions for incoming data. If the UE does not receive the PEI on the first PEI occasion, the UE may continue to monitor subsequent PEI occasions. However, the UE may stop monitoring subsequent PEI occasions once the data has been received. Accordingly, the network may indicate a stop trigger implicitly or explicitly to the UE. In some cases, the stop trigger may be an indication in a short message or downlink control information (DCI). Additionally, or alternatively, the UE may stop monitoring after receiving any downlink transmission.

### FIELD OF TECHNOLOGY

The following relates to wireless communications, including paging early indication in shared spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, a UE may not have an active transmission. As such, the UE may operate in an idle state, in which the UE is not actively monitoring for data, in order to conserve power. If new data for the UE arrives while the UE is in the idle state, the network may alert the UE of the new data by sending a paging message. The UE may respond to the paging message by transitioning out of the idle state in order to receive the incoming transmission.

### SUMMARY

The described techniques relate to improved methods, systems, devices, and apparatuses that support paging early indication (PEI) in shared spectrum. For example, the described techniques provide for a user equipment (UE) to receive an indication to stop monitoring PEI occasions. A network entity may configure the UE with multiple PEI occasions to monitor for PEI. For example, the UE and the network entity may communicate on a shared radio frequency spectrum band, and the multiple PEI occasions may provide multiple opportunities for the network entity to pass a shared channel access procedure, such as a listen-before-talk (LBT) procedure. The network entity may gain access to a wireless channel but may not have any messages to transmit to the UE. The network entity may transmit an indication that the network entity has gained access to the wireless channel but does not have any messages for the UE, indicating to stop monitoring remaining PEI occasions for PEI. For example, the UE may receive a short message or control signaling including an indication (e.g., a flag or set bit index) to not monitor the remaining PEI occasions of the cycle. In other cases, the UE may determine to not monitor the remaining PEI occasions of the cycle based on an implicit indication, such as downlink signaling from the network entity to the UE or other UEs. The UE may skip, or refrain from monitoring, additional PEI occasions until a next paging occasion based on receiving the indication.

A method for wireless communications at a UE is described. The method may include monitoring a first PEI occasion of a set of multiple PEI occasions, where the set of multiple PEI occasions are configured to indicate whether the UE is to process or skip one or more upcoming paging occasions, receiving, based on monitoring the first PEI occasion, an indication that a network entity successfully performed a shared spectrum channel access procedure and has no additional messages to transmit to the UE in the one or more upcoming paging occasions, and skipping monitoring of remaining PEI occasions of the set of multiple PEI occasions based on receiving the indication.

An apparatus for wireless communications at a UE is described. The apparatus may include a processor, memory coupled with the processor, and instructions stored in the memory. The instructions may be executable by the processor to cause the apparatus to monitor a first PEI occasion of a set of multiple PEI occasions, where the set of multiple PEI occasions are configured to indicate whether the UE is to process or skip one or more upcoming paging occasions, receive, based on monitoring the first PEI occasion, an indication that a network entity successfully performed a shared spectrum channel access procedure and has no additional messages to transmit to the UE in the one or more upcoming paging occasions, and skip monitoring of remaining PEI occasions of the set of multiple PEI occasions based on receiving the indication.

Another apparatus for wireless communications at a UE is described. The apparatus may include means for monitoring a first PEI occasion of a set of multiple PEI occasions, where the set of multiple PEI occasions are configured to indicate whether the UE is to process or skip one or more upcoming paging occasions, means for receiving, based on monitoring the first PEI occasion, an indication that a network entity successfully performed a shared spectrum channel access procedure and has no additional messages to transmit to the UE in the one or more upcoming paging occasions, and means for skipping monitoring of remaining PEI occasions of the set of multiple PEI occasions based on receiving the indication.

A non-transitory computer-readable medium storing code for wireless communications at a UE is described. The code may include instructions executable by a processor to monitor a first PEI occasion of a set of multiple PEI occasions, where the set of multiple PEI occasions are configured to indicate whether the UE is to process or skip one or more upcoming paging occasions, receive, based on monitoring the first PEI occasion, an indication that a network entity successfully performed a shared spectrum channel access procedure and has no additional messages to transmit to the UE in the one or more upcoming paging occasions, and skip monitoring of remaining PEI occasions of the set of multiple PEI occasions based on receiving the indication.

Some examples of the method, apparatuses, and non-transitory computer-readable medium described herein may further include operations, features, means, or instructions for receiving a broadcast signal indicating that the network entity supports transmitting the indication, where monitoring the first PEI occasion may be based on the broadcast signal.

In some examples of the method, apparatuses, and non-transitory computer-readable medium described herein, receiving the indication may include operations, features, means, or instructions for receiving a short message indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the short message includes a flag indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the short message may be received via control signaling for PEI.

In some examples of the method, apparatuses, and non-transitory computer-readable medium described herein, receiving the indication may include operations, features, means, or instructions for receiving a PEI including downlink control information indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the downlink control information includes a flag indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the shared spectrum channel access procedure may be a clear channel assessment or an LBT procedure.

In some examples of the method, apparatuses, and non-transitory computer-readable medium described herein, receiving the indication may include operations, features, means, or instructions for receiving a PEI for a subgroup of the UE or for a different subgroup than the subgroup of the UE, where receiving the PEI for the subgroup of the UE or for the different subgroup indicates that the network entity successfully performed the shared spectrum channel access procedure and may have no additional messages to transmit to the UE or the subgroup of the UE in the one or more upcoming paging occasions.

In some examples of the method, apparatuses, and non-transitory computer-readable medium described herein, monitoring the first PEI occasion may include operations, features, means, or instructions for monitoring the first PEI occasion as a relay UE for a remote UE, where the set of multiple PEI occasions may be configured for the remote UE.

In some examples of the method, apparatuses, and non-transitory computer-readable medium described herein, monitoring the first PEI occasion may include operations, features, means, or instructions for monitoring the first PEI occasion of the set of multiple PEI occasions on an unlicensed radio frequency spectrum band or a licensed radio frequency spectrum band.

A method for wireless communications at a network entity is described. The method may include performing a shared spectrum channel access procedure to obtain access to a wireless channel of a shared spectrum and transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

An apparatus for wireless communications at a network entity is described. The apparatus may include a processor, memory coupled with the processor, and instructions stored in the memory. The instructions may be executable by the processor to cause the apparatus to perform a shared spectrum channel access procedure to obtain access to a wireless channel of a shared spectrum and transmit, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

Another apparatus for wireless communications at a network entity is described. The apparatus may include means for performing a shared spectrum channel access procedure to obtain access to a wireless channel of a shared spectrum and means for transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

A non-transitory computer-readable medium storing code for wireless communications at a network entity is described. The code may include instructions executable by a processor to perform a shared spectrum channel access procedure to obtain access to a wireless channel of a shared spectrum and transmit, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

Some examples of the method, apparatuses, and non-transitory computer-readable medium described herein may further include operations, features, means, or instructions for transmitting a broadcast signal indicating that the network entity supports transmitting the indication, where transmitting the indication may be based on the broadcast signal.

In some examples of the method, apparatuses, and non-transitory computer-readable medium described herein, transmitting the indication may include operations, features, means, or instructions for transmitting a short message indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the short message includes a flag indicating that the network entity successfully performed the shared spectrum channel access procedure and may have no additional messages to transmit to the UE in the one or more upcoming paging occasions.

In some examples of the method, apparatuses, and non-transitory computer-readable medium described herein, transmitting the indication may include operations, features, means, or instructions for transmitting a PEI including downlink control information indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the downlink control information includes a flag indicating that the network entity successfully performed the shared spectrum channel access procedure and may have no additional messages to transmit to the UE in the one or more upcoming paging occasions.

In some examples of the method, apparatuses, and non-transitory computer-readable medium described herein, the short message may be transmitted via control signaling for PEI.

In some examples of the method, apparatuses, and non-transitory computer-readable medium described herein, the shared spectrum channel access procedure may be a clear channel assessment or an LBT procedure.

In some examples of the method, apparatuses, and non-transitory computer-readable medium described herein, transmitting the indication may include operations, features, means, or instructions for transmitting a PEI for a subgroup of the UE or a different subgroup than the subgroup of the UE, where transmitting the PEI for the subgroup of the UE or the different subgroup indicates that the network entity successfully performed the shared spectrum channel access procedure and may have no additional messages to transmit to the UE or the subgroup of the UE in the one or more upcoming paging occasions.

In some examples of the method, apparatuses, and non-transitory computer-readable medium described herein, the wireless channel may be on an unlicensed radio frequency spectrum band.

### BRIEF DESCRIPTION OF THE DRAWINGS

FIG. 1 illustrates an example of a wireless communications system that supports paging early indication (PEI) in shared spectrum in accordance with one or more aspects of the present disclosure.

FIG. 2 illustrates an example of a wireless communications system that supports PEI in shared spectrum in accordance with one or more aspects of the present disclosure.

FIG. 3 illustrates an example of a process flow that supports PEI in shared spectrum in accordance with one or more aspects of the present disclosure.

FIGS. 4 and 5 show block diagrams of devices that support PEI in shared spectrum in accordance with one or more aspects of the present disclosure.

FIG. 6 shows a block diagram of a communications manager that supports PEI in shared spectrum in accordance with one or more aspects of the present disclosure.

FIG. 7 shows a diagram of a system including a device that supports PEI in shared spectrum in accordance with one or more aspects of the present disclosure.

FIGS. 8 and 9 show block diagrams of devices that support PEI in shared spectrum in accordance with one or more aspects of the present disclosure.

FIG. 10 shows a block diagram of a communications manager that supports PEI in shared spectrum in accordance with one or more aspects of the present disclosure.

FIG. 11 shows a diagram of a system including a device that supports PEI in shared spectrum in accordance with one or more aspects of the present disclosure.

FIGS. 12 through 15 show flowcharts illustrating methods that support PEI in shared spectrum in accordance with one or more aspects of the present disclosure.

### DETAILED DESCRIPTION

In some wireless communication systems, a user equipment (UE) may monitor for a paging early indication (PEI) over multiple paging occasions. A network entity may transmit a PEI to a UE prior to a paging occasion for the UE to indicate that there is a pending paging message for the UE in a next paging occasion. In some cases, a network entity may configure the UE with multiple PEI occasions. For example, the UE and the network may communicate on a radio frequency spectrum band in shared or unlicensed spectrum, and the network entity may perform a shared spectrum channel access procedure, such as a clear channel assessment or listen-before-talk (LBT), before gaining channel access. For example, if the network entity fails an LBT procedure and is unable to transmit a PEI over a current paging occasion, the network entity may attempt to retransmit the PEI on a following PEI occasion. The UE may continue to monitor the PEI occasions associated with a paging occasion until a PEI is received or all of the PEI occasions have expired. However, in some cases the network entity may successfully perform the shared spectrum channel access procedure, but the network entity may not have any messages for the UE. In current systems, the network entity may not transmit a PEI to the UE unless the network entity has a paging message for the UE, but the UE may continue to monitor each PEI occasion in case the network entity has been unsuccessful at performing the shared spectrum channel access procedure. As such, the UE may consume power monitoring PEI occasions even though the network entity may not transmit a PEI for the remainder of the PEI occasions for the paging occasion.

The techniques, methods, and apparatuses described herein provide for a UE to determine when to stop monitoring PEI occasions for a PEI. For example, a UE may be configured with multiple PEI occasions for one or more paging occasions. For example, the UE and a network entity may communicate on shared radio frequency spectrum, and the multiple PEI occasions may provide multiple opportunities for the network entity to pass a shared spectrum channel access procedure. The network entity may perform and pass the shared spectrum channel access procedure, but the network entity may not have any messages (e.g., paging messages) for the UE. The network entity may transmit an indication that the network entity successfully performed the shared spectrum channel access procedure and has no additional messages to transmit to the UE. For example, the network entity may not have any paging messages for the UE, but the network entity may transmit the indication so that the UE can refrain from monitoring, or skip, remaining PEI occasions until the next paging occasion cycle.

In some cases, the UE may receive an explicit indication to stop monitoring the remaining PEI occasions based on a stop trigger indicated in a short message, downlink control information, PEI, or any combination thereof. The trigger may be an indication that the network entity successfully performed a shared spectrum channel access procedure (e.g., LBT procedure) and has no additional messages to transmit to the UE in one or more upcoming paging occasions. Accordingly, the UE may skip the remaining PEI occasions of the cycle by operating in an idle state. In other cases, the UE may determine to stop monitoring the remaining PEI occasions based on an implicit indication, such as the network entity transmitting downlink control information or another downlink transmission (e.g., to the UE or another UE), which may imply that the network entity successfully performed a shared spectrum channel access procedure. In such cases, the UE may be previously configured to determine that any paging message sent by the network entity may be transmitted on the first successful channel access performed by the network entity. Therefore, if the network entity successfully transmits data to the UE that does not include a PEI, the UE may determine that the network entity has no additional message to transmit to the UE.

Aspects of the disclosure are initially described in the context of wireless communications systems. An additional wireless communication system and process flow are provided to describe aspects of the disclosure. Aspects of the disclosure are further illustrated by and described with reference to apparatus diagrams, system diagrams, and flowcharts that relate to PEI in shared spectrum.

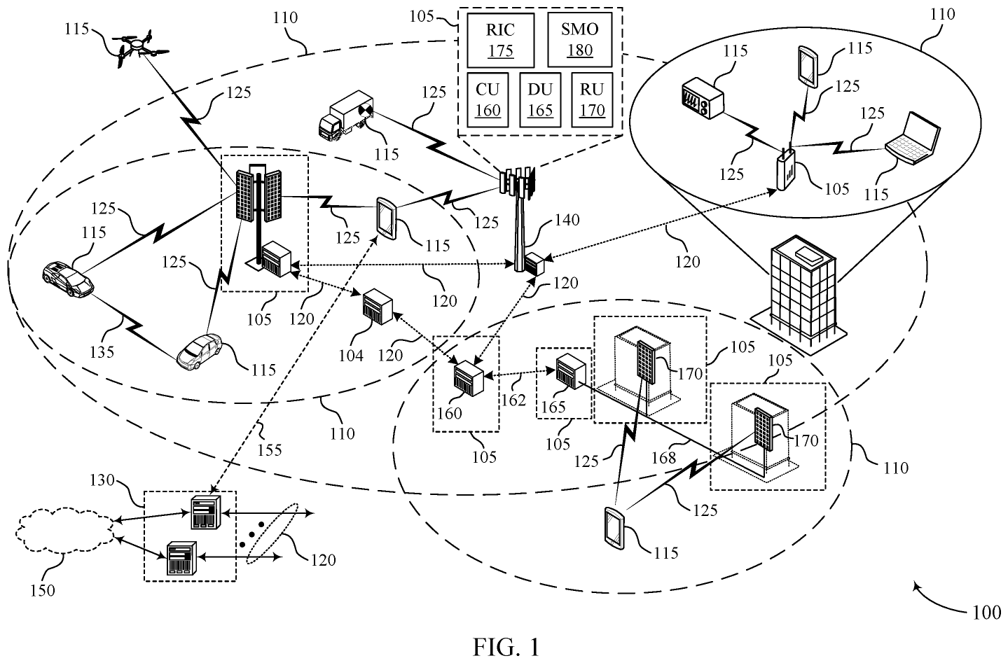

FIG. 1 illustrates an example of a wireless communications system 100 that supports PEI in shared spectrum in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the TAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support PEI in shared spectrum as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communication systems, the UE 115 may enter an idle mode if the UE 115 is not actively receiving data transmission in order to conserve power. As such, the UE 115 may limit data reception to monitoring periodic paging occasions for incoming data transmissions. A paging occasion may refer to the period of time during which the UE 115 is active to receive an indication that the network has a data transmission for the UE 115.

In some cases, a transmitter may perform a spectrum shared channel access, such as an LBT procedure. If the LBT procedure fails, the transmitter may not have access to the channel and may be unable to transmit data. A network entity 105 may be an example of transmitter that performs an LBT procedure to gain channel access. To account for LBT failures at the network entity 105, the UE 115 may monitor for a paging message across multiple paging occasions within a paging cycle. For example, if the network entity 105 fails to transmit a paging message on the first paging occasion of the paging cycle (e.g., due to LBT failure), the network entity 105 may attempt to transmit the paging message on the second paging occasion of the paging cycle. If repeated attempts to transmit the paging message fail, the network entity 105 may continue to attempt to retransmit the paging message on the next available paging occasion.

In some cases, a UE 115 may receive a PEI before a paging occasion, which indicates whether a network entity 105 has data for the UE 115 and will transmit a paging message to the UE 115 during the next upcoming paging occasion. In some cases, a PEI may indicate one or more paged UE subgroups (e.g., a subgroup of the UE 115 or a different subgroup than the subgroup of the UE 115). In some cases, a PEI may provide the benefit of being more power efficient than the UE 115 relying solely on a paging message. In some cases, the network entity 105 may transmit a PEI to the UE 115 indicating whether a subsequent paging occasion includes a scheduled paging message for the UE 115. For example, the network entity 105 may transmit a PEI to indicate whether the UE 115 is paged before the paging opportunity. Some UEs 115 may be configured into sub-groups for PEI signaling, where a PEI transmission indicates groups of UEs 115 to wake up for a paging occasion. PEI techniques may improve power savings at the UE 115, such as by reducing unnecessary paging physical downlink shared channel (PDSCH) decoding, enabling the UE 115 to skip synchronization signal block (SSB) reception for tracking loop updates for PDSCH decoding, and reducing wakeup duration when PEI is placed close to an SSB.

In some cases, the UE 115 may monitor for a PEI across multiple PEI occasions within a PEI paging cycle. However, such monitoring may lead to increased power consumption. Specifically, the UE 115 may consume power monitoring for PEIs when the network entity 105 may not have data for the UE 115 and therefore may not send a PEI. If the network entity 105 has data for the UE 115, the network entity 105 may transmit a PEI after a successful channel access attempt (e.g., first successful LBT attempt). However, UEs 115 in some systems may not know if the network entity 105 has been unable to gain access to the channel or if the network entity 105 does not have any data for the UE 115.

Some wireless communications systems, such as the wireless communications system 100, may support techniques for a network entity 105 to transmit an indication that the network entity 105 has successfully performed a shared spectrum channel access procedure, but the network entity 105 does not have any data messages or paging messages for a UE 115. For example, the network entity 105 may transmit a stop trigger to the UE 115 indicating that the UE 115 may stop monitoring remaining PEI occasions in the PEI paging cycle (e.g., associated with one or more paging occasions). In some examples, the network entity 105 may transmit a short message, PEI, DCI, or any combination thereof, to the UE 115 which includes the indication or the stop trigger. A UE 115 may receive the indication and refrain from monitoring, or skip, remaining PEI occasions associated with the one or more paging occasions until a next set of paging occasions or a next set of PEI occasions.

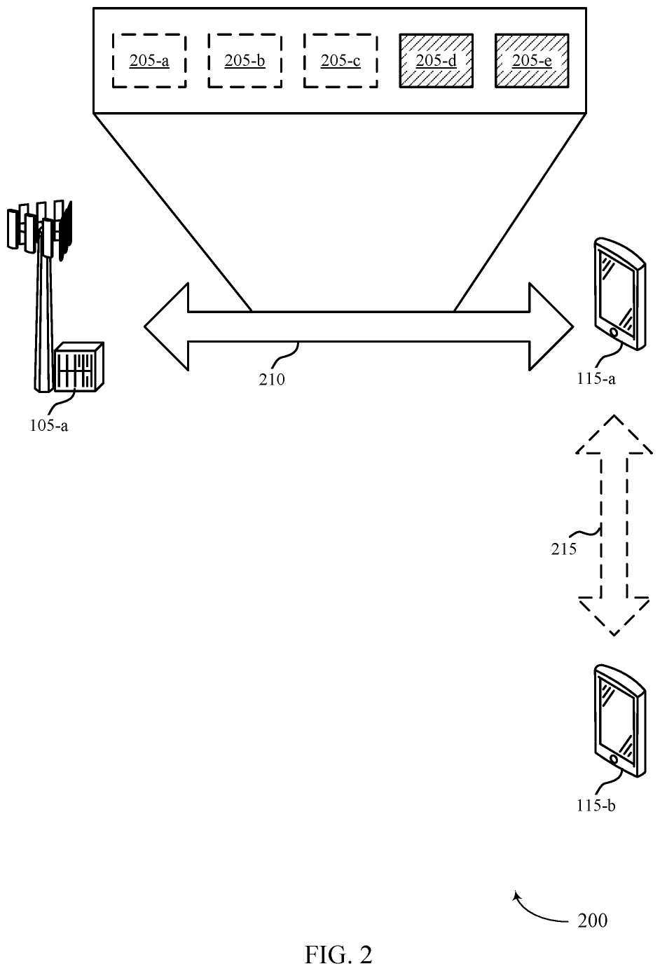

FIG. 2 illustrates an example of a wireless communications system 200 that supports PEI in shared spectrum in accordance with one or more aspects of the present disclosure. The communications system 200 may illustrate an example for implementing one or more aspects of the wireless communications system 100. For example, the communications system 200 illustrates communication between a UE 115-a, a UE 115-b, and a network entity 105-a. The UE 115-a and the UE 115-b may each be an example of a UE 115 described with reference to FIG. 1. The network entity 105-a may be an example of a network entity 105 as described with reference to FIG. 1. The UE 115-a and the network entity 105-a may communicate over communications link 210. The UE 115-a and the network entity 105-a may communicate on licensed or shared channel spectrum, or both. The UE 115-a and the UE 115-b may communicate over a sidelink communication link 215, which may be an example of PC5. In some cases, the UE 115-b may be a remote UE (e.g., out of coverage of the network entity 105-a).

In some examples, the UE 115-a may operate in an idle mode to save power. For example, the UE 115-a may not actively monitor for data transmissions from the network entity 105-a when operating in the idle mode. However, the UE 115-a may perform limited monitoring on paging occasions when operating in an idle mode. As such, the network entity 105-a may transmit a paging message to the UE 115-a on a paging occasion to alert the UE 115-a of an upcoming data transmission. In some cases, the network entity 105-a may transmit a PEI to the UE 115-a before a paging occasion, which alerts the UE 115-a that the network entity 105-a has a paging message to transmit on the next paging occasion. Accordingly, the UE 115-a may monitor for a PEI from the network entity 105-a during a first set of PEI occasions 205.

In some examples, the network entity 105-a may configure the UE 115-a with the first set of PEI occasions 205 associated with one or more paging occasion. In some cases, the network entity 105-a may configure multiple PEI occasions 205 associated with one or more paging occasions for the UE 115-a. For example, the network entity 105-a and the UE 115-a may communicate on resources in a shared spectrum, and the network entity 105-a may perform a shared spectrum channel access procedure, such as an LBT procedure, prior to transmitting on the shared spectrum. Configuring multiple PEI occasions 205 for a paging occasion may provide multiple opportunities for the network entity 105-a to successfully perform a shared spectrum channel access procedure and transmit a PEI to the UE 115-a.

For example, the network entity 105-a may perform a shared spectrum channel access procedure (e.g., LBT procedure) to obtain access to the wireless channel of a shared spectrum before transmitting a PEI or paging message. In some cases, the network entity 105-a may experience an LBT failure and may not gain channel access. If the network entity 105-a does not pass the shared spectrum channel access procedure, the network entity 105-a may be unable to transmit on the channel during a first PEI occasion 205-e of the first set of PEI occasions 205. The network entity 105-a may attempt to transmit the PEI on the next PEI occasion 205-d. If the network entity 105-a experiences repeated failures to gain access to the channel, the network entity 105-a may continue to attempt to transmit the PEI on each subsequent PEI occasion 205.

The wireless communications system 200 may support techniques for a network entity 105, such as the network entity 105-a, to indicate that the network entity 105 has successfully performed a shared channel access procedure but does not have any messages (e.g., paging messages) for a UE 115. For example, the network entity 105-a may successfully perform a shared channel access procedure and transmit the indication to the UE 115-a during a PEI occasion 205. Based on receiving the indication that the network entity 105-a has successfully performed the shared channel access procedure, but has no additional messages for the UE 115-a, the UE 115-a may skip, or refrain from monitoring, any additional PEI occasions 205 of the first set of PEI occasions 205 until a next (e.g., different) set of PEI occasions 205 associated with a next paging occasion. In some examples, the indication may be referred to as a stop trigger, which indicates for the UE 115-a to stop monitoring, or skip, remaining PEI occasions 205 in a set of PEI occasions 205 (e.g., until after the current paging occasion).

For example, the network entity 105-a may not have any messages for the UE 115-a for a paging occasion. The network entity 105-a may perform a shared spectrum channel access procedure and attempt to transmit the indication to the UE 115-a. The network entity 105-a may successfully perform the shared spectrum channel access procedure and transmit the indication to the UE 115-a during PEI occasion 205-d. The UE 115-a may receive the indication during PEI occasion 205-d and identify that the network entity 105-a has successfully gained access to the wireless channel but does not have any additional messages for the UE 115-a. The UE 115-a may skip monitoring the other PEI occasions 205 in the set of PEI occasions 205 and remain in a lower power state. For example, the UE 115-a may skip monitoring PEI occasion 205-c, PEI occasion 205-b, and PEI occasion 205-a.

In some examples, the UE 115-a may resume monitoring PEI occasions 205 during a next set of PEI occasions 205. For example, after one or more paging occasions associated with the first set of PEI occasions 205 occur, the UE 115-a may resume monitoring PEI occasions 205 to check for PEI and pending data from the network entity 105-a or check for the indication that the network entity 105-a does not have any data for the UE 115-a.

In some examples, the network entity 105-a may transmit a short message to indicate that the network entity 105-a has successfully performed a shared spectrum channel access procedure but has no additional messages for the UE 115-a. For example, the network entity 105-a may transmit, and the UE 115-a may receive, a short message indicating to stop monitoring additional occasions for PEI. In some examples, the short messages may include a flag or a toggled bit indicating to stop monitoring, or skip, the additional occasions for PEI. In some cases, the flag or toggled bit may be a dedicated flag or dedicated bit to indicate to stop monitoring for PEI. Additionally, or alternatively, the flag or bit may correspond to another indication (e.g., in a short message used in other signaling). In some examples, the short message may be transmitted in PEI downlink control information.

In some examples, the network entity 105-a may transmit PEI downlink control information to indicate that the network entity has successfully performed a shared spectrum channel access procedure but has no additional messages for the UE 115-a. For example, the network entity 105-a may transmit, and the UE 115-a may receive, PEI downlink control information indicating to stop monitoring, or skip, additional occasions for PEI. In some examples, the PEI downlink control information may include a bit indicating to skip monitoring remaining PEI occasions 205. In some examples, the PEI downlink control information may include any additional downlink control information. In some cases, the PEI downlink control information may be configured for a subgroup of the UE 115-a.

In some cases, the UE 115-a may determine to stop monitoring, or skip, remaining PEI occasions based on an implicit indication that the network entity 105-a has successfully performed the shared spectrum channel access procedure but does not have messages for the UE 115-a. For example, the UE 115-a may receive PEI downlink control information which does not include any information for a subgroup of the UE 115-a. This may indicate that the network entity 105-a has gained access to the wireless channel and can transmit, but the network entity 105-a does not have any messages for the UE 115-a or a subgroup of the UE 115-a. Additionally, or alternatively, if the UE 115-a receives any other downlink control information during a PEI occasion 205, the UE 115-a may determine that the network entity 105-a has gained access to the wireless channel but does not have messages for the UE 115-a. The UE 115-a may skip remaining PEI occasions 205 until a next paging occasion based on the implicit indication.

In some examples, the UE 115-a may be a relay UE 115 for a remote UE 115, such as the UE 115-b. For example, the UE 115-a may monitor for PEI for the UE 115-b. As a relay UE 115, the UE 115-a may be configured with the paging subgroups and PEI occasions for the UE 115-b. When the UE 115-a detects a PEI for the UE 115-b, the UE 115-a may monitor for paging messages and data based on detecting the PEI, and the UE 115-a may relay (e.g., transmit or forward) the paging messages, data messages, control signaling, or any combination thereof, to the UE 115-b. These techniques may be implemented to stop a relay UE 115 from monitoring additional PEI occasions 205 to detect a PEI for the remote UE 115. For example, the UE 115-a may receive an indication that the network entity 105-a has successfully performed a shared spectrum channel access procedure but does not have any additional messages for the UE 115-b. The UE 115-a may skip monitoring the additional PEI occasions and stop monitoring for a PEI for the UE 115-b until a next paging occasion. The indication to a relay UE 115 may similarly be transmitted via a short message, a PEI downlink control information, or implicitly.

While these techniques are generally described with reference to shared spectrum, the techniques may similarly be implemented for licensed spectrum. For example, the network entity 105-a may configure the UE 115-a with multiple PEI occasions for a paging occasion on a licensed spectrum. The network entity 105-a may transmit an indication to the UE 115-a that the network entity 105-a does not have any messages for the UE 115-a, and the UE 115-a can skip remaining PEI occasions for the paging occasion. In some cases, the indication transmitted on the licensed spectrum may just indicate that the network entity 105-a does not have messages for the UE 115-a instead of also indicating a successful shared spectrum channel access procedure.

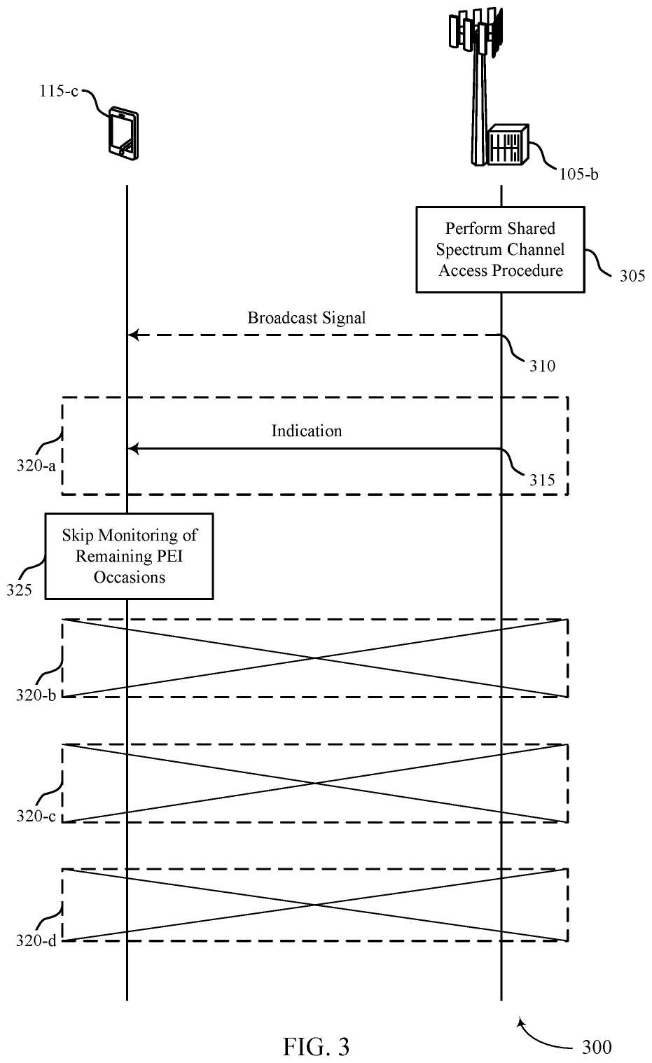

FIG. 3 illustrates an example of a process flow 300 that supports PEI in shared spectrum in accordance with one or more aspects of the present disclosure. In some examples, process flow 300 may be implemented by one or more aspects of wireless communications system 100 and 200 as described in FIGS. 1 and 2. For example, UE 115-c may be an example of UE 115 and network entity 105-b may be an example of network entity 105 as described in FIG. 1. In the following description of the process flow 300, the operations between UE 115-c and network entity 105-b may be transmitted in a different order than the example order shown, or the operations performed may be performed in different orders or at different times. Some operations may also be omitted from the process flow 300, and other operations may be added to the process flow 300.

At 305, network entity 105-b may perform a shared spectrum channel access procedure to obtain access to a wireless channel of a shared spectrum. In some cases, the procedure may be an LBT procedure or a CCA procedure. For example, the network entity 105-b and the UE 115-c may communicate on a wireless channel in shared spectrum. The network entity 105-b may configure the UE 115-c with multiple PEI occasions (e.g., PEI occasions 320-a through 320-d) for a paging occasion, which may provide multiple opportunities for the network entity 105-b to successfully perform the shared spectrum channel access procedure and transmit PEI or an indication to skip monitoring remaining PEI occasions.

In some examples, at 310, UE 115-c may receive a broadcast signal indicating that network entity 105-b supports transmitting an indication that the network entity 105-b has successfully performed the shared spectrum channel access procedure but has no additional messages to transmit to one or more UEs 115 (e.g., the UE 115-c).

The UE 115-c may monitor PEI occasions for PEI or an indication to skip monitoring remaining PEI occasions. For example, at 320-a, the UE 115-c may monitor a first PEI occasion of a set of multiple PEI occasions. The set of multiple PEI occasions may be configured to indicate whether the UE 115-c is to process or skip one or more upcoming paging occasions. For example, if the UE 115-c detects PEI at 320-a, the UE 115-c may enter a higher power state to receive paging signaling during an associated paging occasion.

At 315, the network entity 105-b may transmit, and the UE 115-c may receive, an indication that the network entity 105-b successfully performed the shared spectrum channel access procedure and has no additional messages to transmit to the UE 115-c in one or more upcoming paging occasions. For example, the network entity 105-b may transmit a short message to the UE 115-c indicating that the network entity 105-b successfully performed the shared spectrum channel access procedure and has no additional messages to transmit to the UE 115-c in the one or more upcoming paging occasions. In some examples, the short message may include a flag or bit indicating to skip monitoring the remaining PEI occasions. In some cases, the short messages may be transmitted in PEI downlink control information.

In some examples, the UE 115-c may receive PEI downlink control information including an indication to skip monitoring remaining PEI occasions configured for the paging occasion. The PEI downlink control information may be for a subgroup of the UE 115-c or for another subgroup. In some examples, the PEI downlink control information may explicitly or implicitly indicate to skip monitoring remaining PEI occasions. For example, the PEI downlink control information may include an explicit flag, field, or bit indicating that the network entity 105-b successfully performed the shared spectrum channel access procedure and has no additional messages to transmit to the UE 115-c. In some other examples, the PEI downlink control information may not include any information for the UE 115-c or a subgroup of the UE 115-c, and the UE 115-c may implicitly determine that the network entity 105-a has gained access to the wireless channel but has no additional messages for the UE 115-b.

At 325, the UE 115-c may skip monitoring of remaining PEI occasions (e.g., occasions 320-b through 320-d) of the set of multiple PEI occasions based on receiving the indication. For example, the UE 115-c may skip monitoring PEI occasion 320-b, PEI occasion 320-c, and PEI occasion 320-d after receiving the indication during PEI occasion 320-a. In an example, PEI occasion 320-d may be a last PEI occasion 320 associated with one or more paging occasions. After PEI occasion 320-d, the UE 115-c may resume monitoring PEI occasions (e.g., associated with a next paging occasion) to receive a PEI or an indication that the network entity 105-b has gained access to the wireless channel but does not have any additional messages to send to the UE 115-c.

UE 115-c may determine that network entity 105-b may transmit the PEI on the first PEI occasion 320 of channel access. In some cases, the PEI occasions 320 may be configured to indicate whether UE 115-c may process or skip one or more upcoming paging occasions.

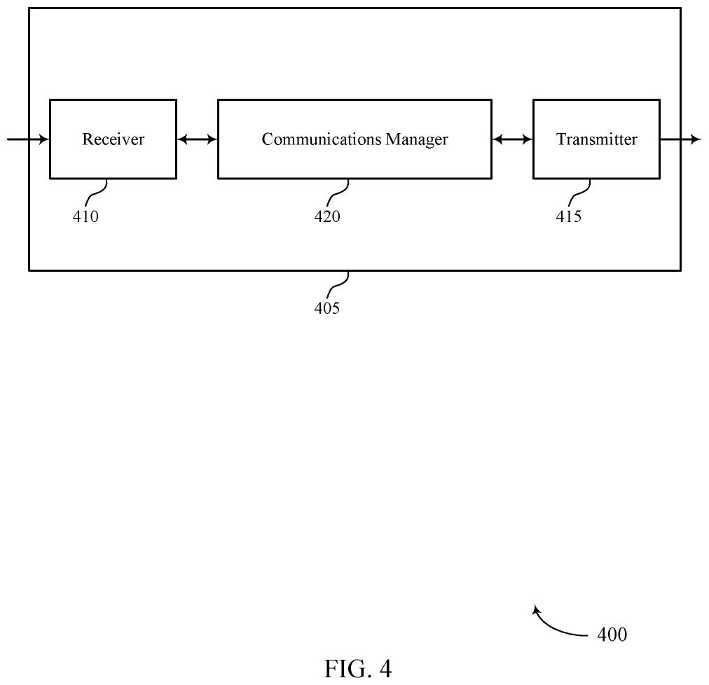

FIG. 4 shows a block diagram 400 of a device 405 that supports PEI in shared spectrum in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to PEI in shared spectrum). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to PEI in shared spectrum). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of PEI in shared spectrum as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for monitoring a first PEI occasion of a set of multiple PEI occasions, where the set of multiple PEI occasions are configured to indicate whether the UE is to process or skip one or more upcoming paging occasions. The communications manager 420 may be configured as or otherwise support a means for receiving, based on monitoring the first PEI occasion, an indication that a network entity successfully performed a shared spectrum channel access procedure and has no additional messages to transmit to the UE in the one or more upcoming paging occasions. The communications manager 420 may be configured as or otherwise support a means for skipping monitoring of remaining PEI occasions of the set of multiple PEI occasions based on receiving the indication.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing, reduced power consumption, and more efficient utilization of communication resources.

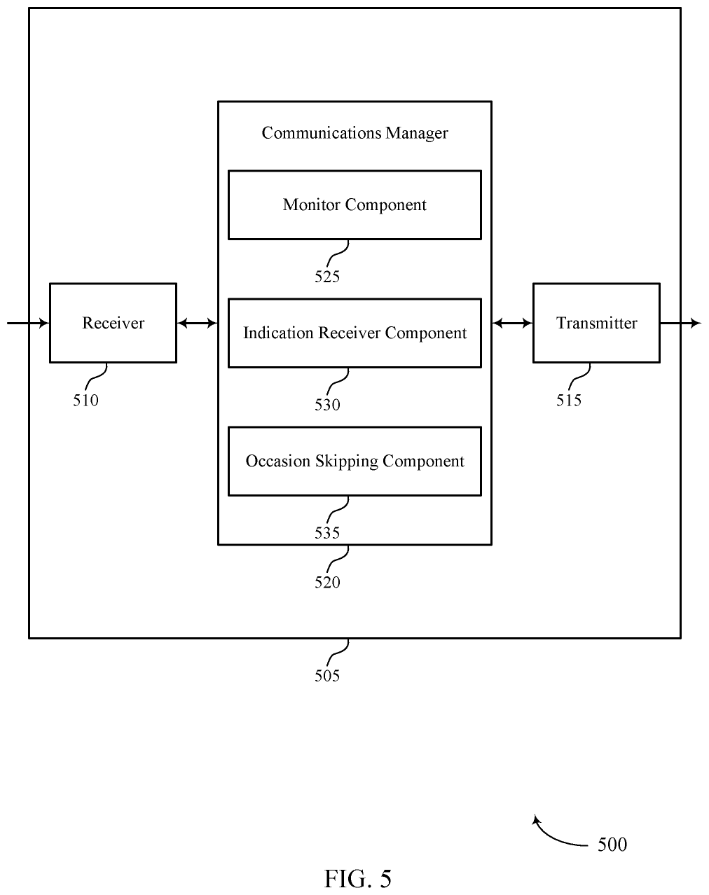

FIG. 5 shows a block diagram 500 of a device 505 that supports PEI in shared spectrum in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to PEI in shared spectrum). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to PEI in shared spectrum). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of PEI in shared spectrum as described herein. For example, the communications manager 520 may include a monitor component 525, an indication receiver component 530, an occasion skipping component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The monitor component 525 may be configured as or otherwise support a means for monitoring a first PEI occasion of a set of multiple PEI occasions, where the set of multiple PEI occasions are configured to indicate whether the UE is to process or skip one or more upcoming paging occasions. The indication receiver component 530 may be configured as or otherwise support a means for receiving, based on monitoring the first PEI occasion, an indication that a network entity successfully performed a shared spectrum channel access procedure and has no additional messages to transmit to the UE in the one or more upcoming paging occasions. The occasion skipping component 535 may be configured as or otherwise support a means for skipping monitoring of remaining PEI occasions of the set of multiple PEI occasions based on receiving the indication.

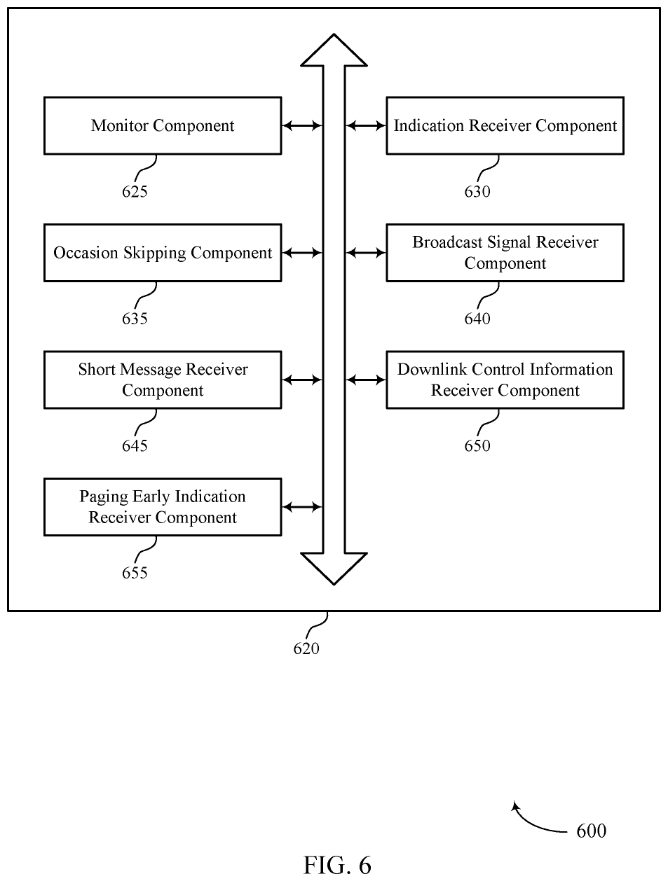

FIG. 6 shows a block diagram 600 of a communications manager 620 that supports PEI in shared spectrum in accordance with one or more aspects of the present disclosure. The communications manager 620 may be an example of aspects of a communications manager 420, a communications manager 520, or both, as described herein. The communications manager 620, or various components thereof, may be an example of means for performing various aspects of PEI in shared spectrum as described herein. For example, the communications manager 620 may include a monitor component 625, an indication receiver component 630, an occasion skipping component 635, a broadcast signal receiver component 640, a short message receiver component 645, a downlink control information receiver component 650, a PEI receiver component 655, or any combination thereof. Each of these components may communicate, directly or indirectly, with one another (e.g., via one or more buses).

The communications manager 620 may support wireless communications at a UE in accordance with examples as disclosed herein. The monitor component 625 may be configured as or otherwise support a means for monitoring a first PEI occasion of a set of multiple PEI occasions, where the set of multiple PEI occasions are configured to indicate whether the UE is to process or skip one or more upcoming paging occasions. The indication receiver component 630 may be configured as or otherwise support a means for receiving, based on monitoring the first PEI occasion, an indication that a network entity successfully performed a shared spectrum channel access procedure and has no additional messages to transmit to the UE in the one or more upcoming paging occasions. The occasion skipping component 635 may be configured as or otherwise support a means for skipping monitoring of remaining PEI occasions of the set of multiple PEI occasions based on receiving the indication.

In some examples, the broadcast signal receiver component 640 may be configured as or otherwise support a means for receiving a broadcast signal indicating that the network entity supports transmitting the indication, where monitoring the first PEI occasion is based on the broadcast signal.

In some examples, to support receiving the indication, the short message receiver component 645 may be configured as or otherwise support a means for receiving a short message indicating that the network entity successfully performed the shared spectrum channel access procedure and has no additional messages to transmit to the UE in the one or more upcoming paging occasions.

In some examples, the short message includes a flag indicating that the network entity successfully performed the shared spectrum channel access procedure and has no additional messages to transmit to the UE in the one or more upcoming paging occasions.

In some examples, the short message is received via control signaling for PEI.

In some examples, to support receiving the indication, the downlink control information receiver component 650 may be configured as or otherwise support a means for receiving a PEI including downlink control information indicating that the network entity successfully performed the shared spectrum channel access procedure and has no additional messages to transmit to the UE in the one or more upcoming paging occasions.

In some examples, the downlink control information includes a flag indicating that the network entity successfully performed the shared spectrum channel access procedure and has no additional messages to transmit to the UE in the one or more upcoming paging occasions.

In some examples, the shared spectrum channel access procedure is a clear channel assessment or an LBT procedure.

In some examples, to support receiving the indication, the PEI receiver component 655 may be configured as or otherwise support a means for receiving a PEI for a subgroup of the UE or for a different subgroup than the subgroup of the UE, where receiving the PEI for the subgroup of the UE or for the different subgroup indicates that the network entity successfully performed the shared spectrum channel access procedure and has no additional messages to transmit to the UE or the subgroup of the UE in the one or more upcoming paging occasions.

In some examples, to support monitoring the first PEI occasion, the monitor component 625 may be configured as or otherwise support a means for monitoring the first PEI occasion as a relay UE for a remote UE, where the set of multiple PEI occasions are configured for the remote UE.

In some examples, to support monitoring the first PEI occasion, the monitor component 625 may be configured as or otherwise support a means for monitoring the first PEI occasion of the set of multiple PEI occasions on an unlicensed radio frequency spectrum band or a licensed radio frequency spectrum band.

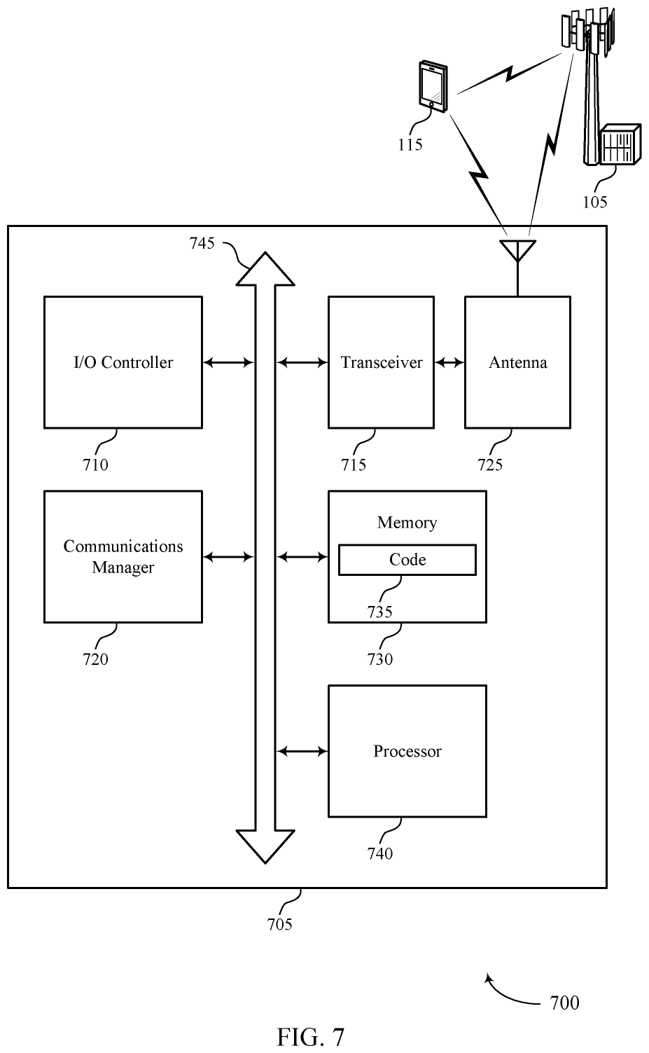

FIG. 7 shows a diagram of a system 700 including a device 705 that supports PEI in shared spectrum in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting PEI in shared spectrum). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for monitoring a first PEI occasion of a set of multiple PEI occasions, where the set of multiple PEI occasions are configured to indicate whether the UE is to process or skip one or more upcoming paging occasions. The communications manager 720 may be configured as or otherwise support a means for receiving, based on monitoring the first PEI occasion, an indication that a network entity successfully performed a shared spectrum channel access procedure and has no additional messages to transmit to the UE in the one or more upcoming paging occasions. The communications manager 720 may be configured as or otherwise support a means for skipping monitoring of remaining PEI occasions of the set of multiple PEI occasions based on receiving the indication.

By including or configuring the communications manager 720 in accordance with examples as described herein, the device 705 may support techniques for reduced power consumption, more efficient utilization of communication resources, and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of PEI in shared spectrum as described herein, or the processor 740 and the memory 730 may be otherwise configured to perform or support such operations.

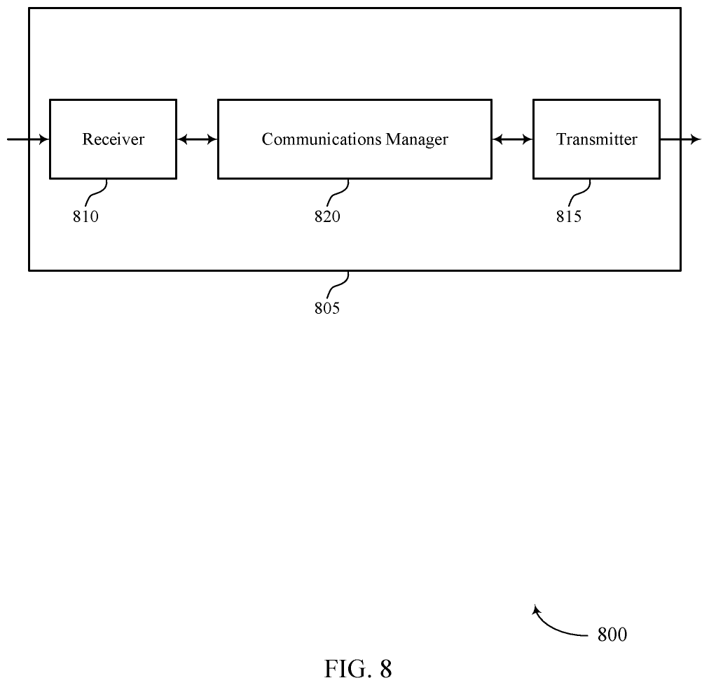

FIG. 8 shows a block diagram 800 of a device 805 that supports PEI in shared spectrum in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of PEI in shared spectrum as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for performing a shared spectrum channel access procedure to obtain access to a wireless channel of a shared spectrum. The communications manager 820 may be configured as or otherwise support a means for transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources.

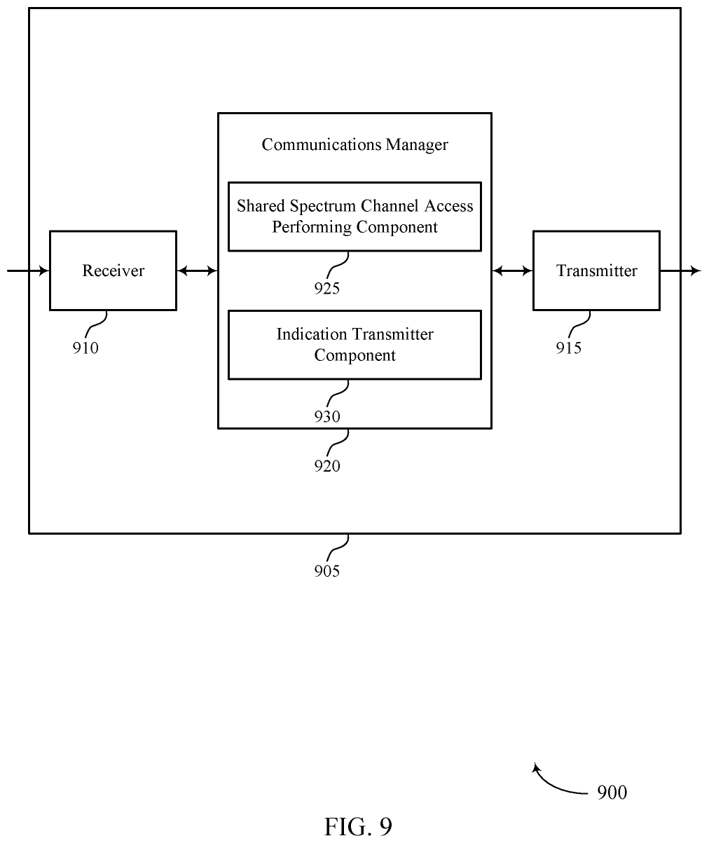

FIG. 9 shows a block diagram 900 of a device 905 that supports PEI in shared spectrum in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of PEI in shared spectrum as described herein. For example, the communications manager 920 may include a shared spectrum channel access performing component 925 an indication transmitter component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The shared spectrum channel access performing component 925 may be configured as or otherwise support a means for performing a shared spectrum channel access procedure to obtain access to a wireless channel of a shared spectrum. The indication transmitter component 930 may be configured as or otherwise support a means for transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

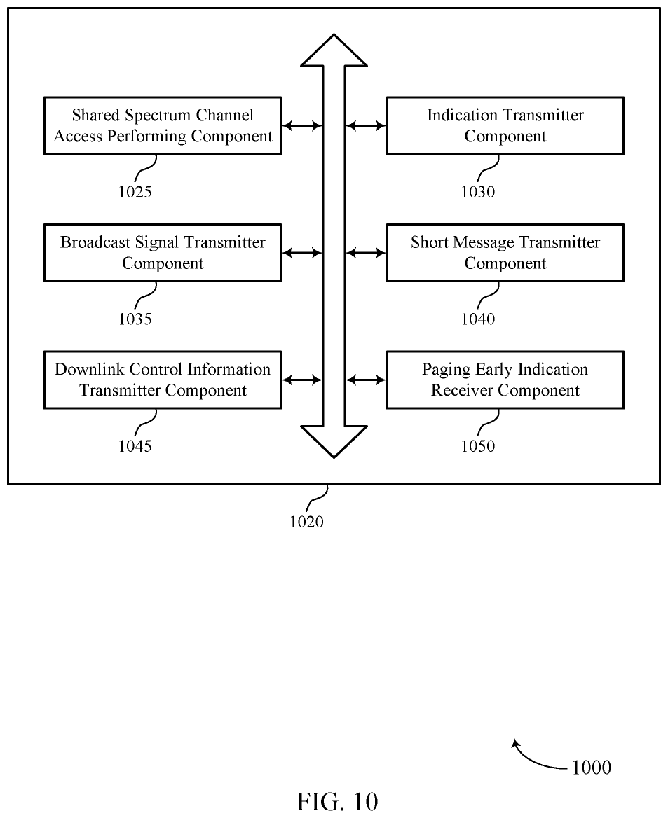

FIG. 10 shows a block diagram 1000 of a communications manager 1020 that supports PEI in shared spectrum in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of PEI in shared spectrum as described herein. For example, the communications manager 1020 may include a shared spectrum channel access performing component 1025, an indication transmitter component 1030, a broadcast signal transmitter component 1035, a short message transmitter component 1040, a downlink control information transmitter component 1045, a PEI receiver component 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The shared spectrum channel access performing component 1025 may be configured as or otherwise support a means for performing a shared spectrum channel access procedure to obtain access to a wireless channel of a shared spectrum. The indication transmitter component 1030 may be configured as or otherwise support a means for transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

In some examples, the broadcast signal transmitter component 1035 may be configured as or otherwise support a means for transmitting a broadcast signal indicating that the network entity supports transmitting the indication, where transmitting the indication is based on the broadcast signal.

In some examples, to support transmitting the indication, the short message transmitter component 1040 may be configured as or otherwise support a means for transmitting a short message indicating that the network entity successfully performed the shared spectrum channel access procedure and has no additional messages to transmit to the UE in the one or more upcoming paging occasions.

In some examples, the short message includes a flag indicating that the network entity successfully performed the shared spectrum channel access procedure and has no additional messages to transmit to the UE in the one or more upcoming paging occasions.

In some examples, to support transmitting the indication, the downlink control information transmitter component 1045 may be configured as or otherwise support a means for transmitting a PEI including downlink control information indicating that the network entity successfully performed the shared spectrum channel access procedure and has no additional messages to transmit to the UE in the one or more upcoming paging occasions.

In some examples, the downlink control information includes a flag indicating that the network entity successfully performed the shared spectrum channel access procedure and has no additional messages to transmit to the UE in the one or more upcoming paging occasions.

In some examples, the short message is transmitted via control signaling for PEI. In some examples, the shared spectrum channel access procedure is a clear channel assessment or an LBT procedure.

In some examples, to support transmitting the indication, the PEI receiver component 1050 may be configured as or otherwise support a means for transmitting a PEI for a subgroup of the UE or a different subgroup than the subgroup of the UE, where transmitting the PEI for the subgroup of the UE or the different subgroup indicates that the network entity successfully performed the shared spectrum channel access procedure and has no additional messages to transmit to the UE or the subgroup of the UE in the one or more upcoming paging occasions. In some examples, the wireless channel is on an unlicensed radio frequency spectrum band.

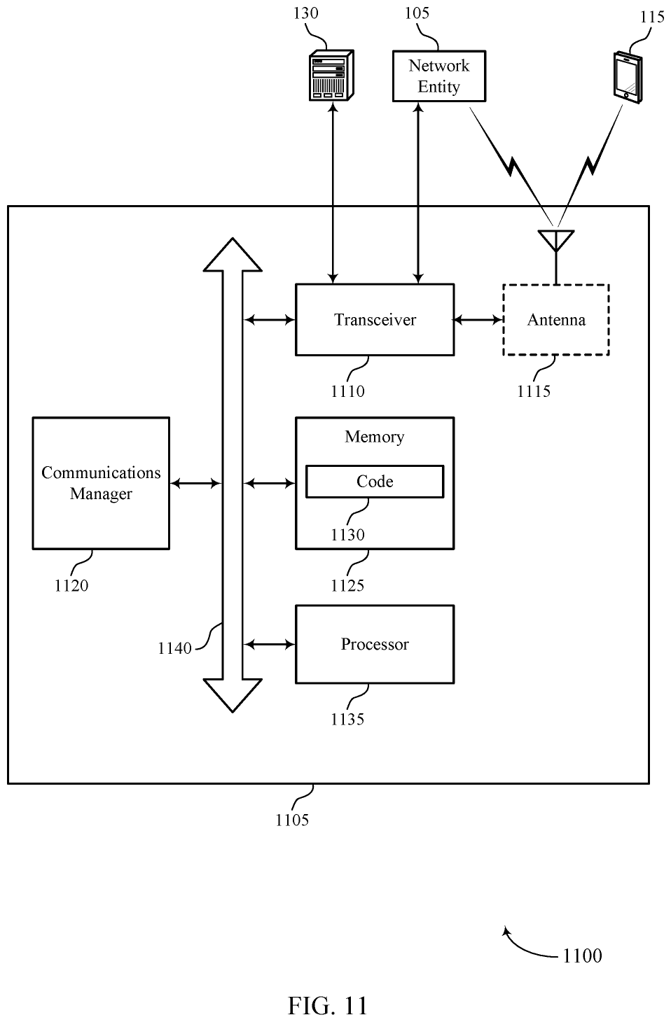

FIG. 11 shows a diagram of a system 1100 including a device 1105 that supports PEI in shared spectrum in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting PEI in shared spectrum). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for performing a shared spectrum channel access procedure to obtain access to a wireless channel of a shared spectrum. The communications manager 1120 may be configured as or otherwise support a means for transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions.

By including or configuring the communications manager 1120 in accordance with examples as described herein, the device 1105 may support techniques for reduced power consumption, more efficient utilization of communication resources, and longer battery life, improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of PEI in shared spectrum as described herein, or the processor 1135 and the memory 1125 may be otherwise configured to perform or support such operations.

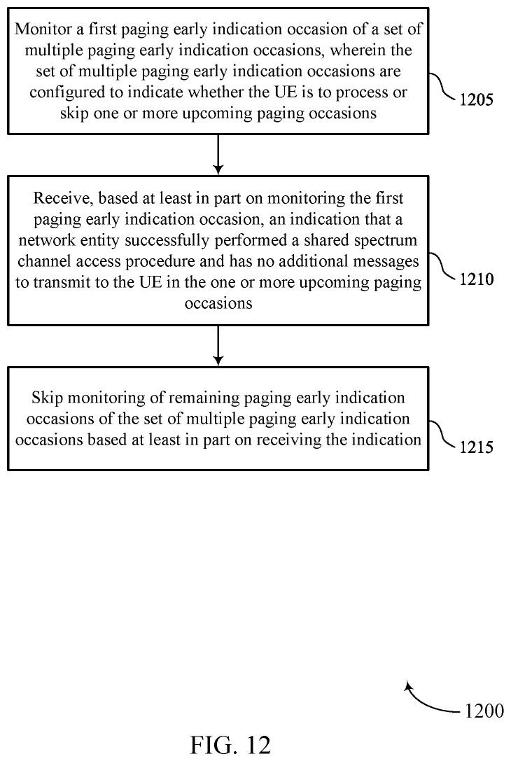

FIG. 12 shows a flowchart illustrating a method 1200 that supports PEI in shared spectrum in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include monitoring a first PEI occasion of a set of multiple PEI occasions, where the set of multiple PEI occasions are configured to indicate whether the UE is to process or skip one or more upcoming paging occasions. The operations of 1205 may be performed in accordance with examples as disclosed herein. In some examples, aspects of the operations of 1205 may be performed by a monitor component 625 as described with reference to FIG. 6.

At 1210, the method may include receiving, based on monitoring the first PEI occasion, an indication that a network entity successfully performed a shared spectrum channel access procedure and has no additional messages to transmit to the UE in the one or more upcoming paging occasions. The operations of 1210 may be performed in accordance with examples as disclosed herein. In some examples, aspects of the operations of 1210 may be performed by an indication receiver component 630 as described with reference to FIG. 6.

At 1215, the method may include skipping monitoring of remaining PEI occasions of the set of multiple PEI occasions based on receiving the indication. The operations of 1215 may be performed in accordance with examples as disclosed herein. In some examples, aspects of the operations of 1215 may be performed by an occasion skipping component 635 as described with reference to FIG. 6.

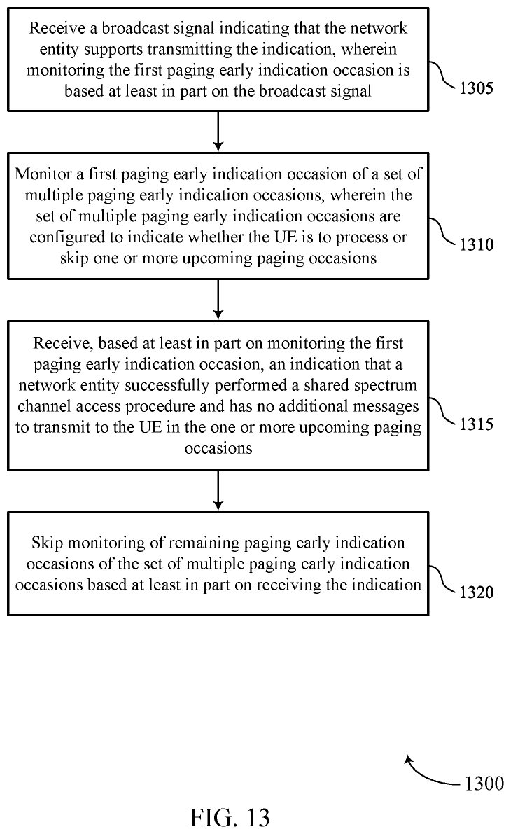

FIG. 13 shows a flowchart illustrating a method 1300 that supports PEI in shared spectrum in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a broadcast signal indicating that the network entity supports transmitting the indication, where monitoring the first PEI occasion is based on the broadcast signal. The operations of 1305 may be performed in accordance with examples as disclosed herein. In some examples, aspects of the operations of 1305 may be performed by a broadcast signal receiver component 640 as described with reference to FIG. 6.

At 1310, the method may include monitoring a first PEI occasion of a set of multiple PEI occasions, where the set of multiple PEI occasions are configured to indicate whether the UE is to process or skip one or more upcoming paging occasions. The operations of 1310 may be performed in accordance with examples as disclosed herein. In some examples, aspects of the operations of 1310 may be performed by a monitor component 625 as described with reference to FIG. 6.

At 1315, the method may include receiving, based on monitoring the first PEI occasion, an indication that a network entity successfully performed a shared spectrum channel access procedure and has no additional messages to transmit to the UE in the one or more upcoming paging occasions. The operations of 1315 may be performed in accordance with examples as disclosed herein. In some examples, aspects of the operations of 1315 may be performed by an indication receiver component 630 as described with reference to FIG. 6.

At 1320, the method may include skipping monitoring of remaining PEI occasions of the set of multiple PEI occasions based on receiving the indication. The operations of 1320 may be performed in accordance with examples as disclosed herein. In some examples, aspects of the operations of 1320 may be performed by an occasion skipping component 635 as described with reference to FIG. 6.

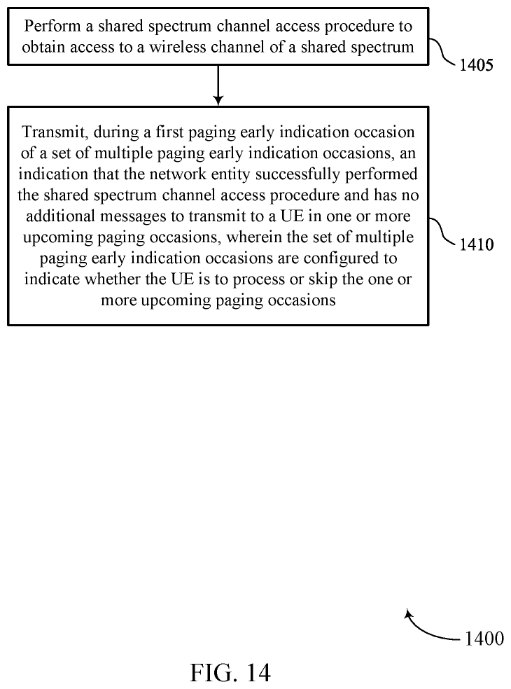

FIG. 14 shows a flowchart illustrating a method 1400 that supports PEI in shared spectrum in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include performing a shared spectrum channel access procedure to obtain access to a wireless channel of a shared spectrum. The operations of 1405 may be performed in accordance with examples as disclosed herein. In some examples, aspects of the operations of 1405 may be performed by a shared spectrum channel access performing component 1025 as described with reference to FIG. 10.

At 1410, the method may include transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions. The operations of 1410 may be performed in accordance with examples as disclosed herein. In some examples, aspects of the operations of 1410 may be performed by an indication transmitter component 1030 as described with reference to FIG. 10.

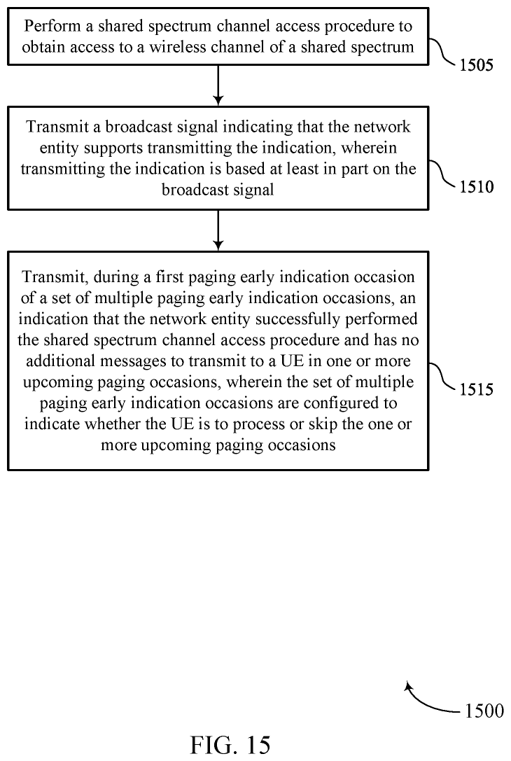

FIG. 15 shows a flowchart illustrating a method 1500 that supports PEI in shared spectrum in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include performing a shared spectrum channel access procedure to obtain access to a wireless channel of a shared spectrum. The operations of 1505 may be performed in accordance with examples as disclosed herein. In some examples, aspects of the operations of 1505 may be performed by a shared spectrum channel access performing component 1025 as described with reference to FIG. 10.

At 1510, the method may include transmitting a broadcast signal indicating that the network entity supports transmitting the indication, where transmitting the indication is based on the broadcast signal. The operations of 1510 may be performed in accordance with examples as disclosed herein. In some examples, aspects of the operations of 1510 may be performed by a broadcast signal transmitter component 1035 as described with reference to FIG. 10.

At 1515, the method may include transmitting, during a first PEI occasion of a set of multiple PEI occasions, an indication that the network entity successfully performed the shared spectrum channel access procedure and has no additional messages to transmit to a UE in one or more upcoming paging occasions, where the set of multiple PEI occasions are configured to indicate whether the UE is to process or skip the one or more upcoming paging occasions. The operations of 1515 may be performed in accordance with examples as disclosed herein. In some examples, aspects of the operations of 1515 may be performed by an indication transmitter component 1030 as described with reference to FIG. 10.

The following provides an overview of aspects of the present disclosure:

Aspect 1: A method for wireless communications at a UE, comprising: monitoring a first paging early indication occasion of a set of multiple paging early indication occasions, wherein the set of multiple paging early indication occasions are configured to indicate whether the UE is to process or skip one or more upcoming paging occasions; receiving, based at least in part on monitoring the first paging early indication occasion, an indication that a network entity successfully performed a shared spectrum channel access procedure and has no additional messages to transmit to the UE in the one or more upcoming paging occasions; and skipping monitoring of remaining paging early indication occasions of the set of multiple paging early indication occasions based at least in part on receiving the indication.

Aspect 2: The method of aspect 1, further comprising: receiving a broadcast signal indicating that the network entity supports transmitting the indication, wherein monitoring the first paging early indication occasion is based at least in part on the broadcast signal.

Aspect 3: The method of any of aspects 1 through 2, wherein receiving the indication comprises: receiving a short message indicating that the network entity successfully performed the shared spectrum channel access procedure and has no additional messages to transmit to the UE in the one or more upcoming paging occasions.

Aspect 4: The method of aspect 3, wherein the short message includes a flag indicating that the network entity successfully performed the shared spectrum channel access procedure and has no additional messages to transmit to the UE in the one or more upcoming paging occasions.

Aspect 5: The method of any of aspects 3 through 4, wherein the short message is received via control signaling for paging early indication.

Aspect 6: The method of any of aspects 1 through 5, wherein receiving the indication comprises: receiving a paging early indication including downlink control information indicating that the network entity successfully performed the shared spectrum channel access procedure and has no additional messages to transmit to the UE in the one or more upcoming paging occasions.

Aspect 7: The method of aspect 6, wherein the downlink control information includes a flag indicating that the network entity successfully performed the shared spectrum channel access procedure and has no additional messages to transmit to the UE in the one or more upcoming paging occasions.

Aspect 8: The method of any of aspects 1 through 7, wherein the shared spectrum channel access procedure is a clear channel assessment or a listen-before-talk procedure.

Aspect 9: The method of any of aspects 1 through 8, wherein receiving the indication comprises: receiving a paging early indication for a subgroup of the UE or for a different subgroup than the subgroup of the UE, wherein receiving the paging early indication for the subgroup of the UE or for the different subgroup indicates that the network entity successfully performed the shared spectrum channel access procedure and has no additional messages to transmit to the UE or the subgroup of the UE in the one or more upcoming paging occasions.

Aspect 10: The method of any of aspects 1 through 9, wherein monitoring the first paging early indication occasion comprises: monitoring the first paging early indication occasion as a relay UE for a remote UE, wherein the set of multiple paging early indication occasions are configured for the remote UE.

Aspect 11: The method of any of aspects 1 through 10, wherein monitoring the first paging early indication occasion comprises: monitoring the first paging early indication occasion of the set of multiple paging early indication occasions on an unlicensed radio frequency spectrum band or a licensed radio frequency spectrum band.

Aspect 12: A method for wireless communications at a network entity, comprising: performing a shared spectrum channel access procedure to obtain access to a wireless channel of a shared spectrum; and transmitting, during a first paging early indication occasion of a set of multiple paging early indication occasions, an indication that the network entity successfully performed the shared spectrum channel access procedure and has no additional messages to transmit to a UE in one or more upcoming paging occasions, wherein the set of multiple paging early indication occasions are configured to indicate whether the UE is to process or skip the one or more upcoming paging occasions.

Aspect 13: The method of aspect 12, further comprising: transmitting a broadcast signal indicating that the network entity supports transmitting the indication, wherein transmitting the indication is based at least in part on the broadcast signal.

Aspect 14: The method of any of aspects 12 through 13, wherein transmitting the indication comprises: transmitting a short message indicating that the network entity successfully performed the shared spectrum channel access procedure and has no additional messages to transmit to the UE in the one or more upcoming paging occasions.

Aspect 15: The method of aspect 14, wherein the short message includes a flag indicating that the network entity successfully performed the shared spectrum channel access procedure and has no additional messages to transmit to the UE in the one or more upcoming paging occasions.

Aspect 16: The method of any of aspects 12 through 15, wherein transmitting the indication comprises: transmitting a paging early indication including downlink control information indicating that the network entity successfully performed the shared spectrum channel access procedure and has no additional messages to transmit to the UE in the one or more upcoming paging occasions.

Aspect 17: The method of aspect 16, wherein the downlink control information includes a flag indicating that the network entity successfully performed the shared spectrum channel access procedure and has no additional messages to transmit to the UE in the one or more upcoming paging occasions.

Aspect 18: The method of any of aspects 16 through 17, wherein the short message is transmitted via control signaling for paging early indication.

Aspect 19: The method of any of aspects 12 through 18, wherein the shared spectrum channel access procedure is a clear channel assessment or a listen-before-talk procedure.

Aspect 20: The method of any of aspects 12 through 19, wherein transmitting the indication comprises: transmitting a paging early indication for a subgroup of the UE or a different subgroup than the subgroup of the UE, wherein transmitting the paging early indication for the subgroup of the UE or the different subgroup indicates that the network entity successfully performed the shared spectrum channel access procedure and has no additional messages to transmit to the UE or the subgroup of the UE in the one or more upcoming paging occasions.

Aspect 21: The method of any of aspects 12 through 20, wherein the wireless channel is on an unlicensed radio frequency spectrum band.

Aspect 22: An apparatus for wireless communications at a UE, comprising a processor; memory coupled with the processor; and instructions stored in the memory and executable by the processor to cause the apparatus to perform a method of any of aspects 1 through 11.

Aspect 23: An apparatus for wireless communications at a UE, comprising at least one means for performing a method of any of aspects 1 through 11.

Aspect 24: A non-transitory computer-readable medium storing code for wireless communications at a UE, the code comprising instructions executable by a processor to perform a method of any of aspects 1 through 11.

Aspect 25: An apparatus for wireless communications at a network entity, comprising a processor; memory coupled with the processor; and instructions stored in the memory and executable by the processor to cause the apparatus to perform a method of any of aspects 12 through 21.

Aspect 26: An apparatus for wireless communications at a network entity, comprising at least one means for performing a method of any of aspects 12 through 21.

Aspect 27: A non-transitory computer-readable medium storing code for wireless communications at a network entity, the code comprising instructions executable by a processor to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
monitoring a first paging early indication occasion of a set of multiple paging early indication occasions, wherein the set of multiple paging early indication occasions are configured to indicate whether the UE is to process or skip one or more upcoming paging occasions;
receiving, based at least in part on monitoring the first paging early indication occasion, an indication that a network entity successfully performed a shared spectrum channel access procedure and has no additional messages to transmit to the UE in the one or more upcoming paging occasions; and
skipping monitoring of remaining paging early indication occasions of the set of multiple paging early indication occasions based at least in part on receiving the indication.

2. The method of claim 1, further comprising:
receiving a broadcast signal indicating that the network entity supports transmitting the indication, wherein monitoring the first paging early indication occasion is based at least in part on the broadcast signal.

3. The method of claim 1, wherein receiving the indication comprises:
receiving a short message indicating that the network entity successfully performed the shared spectrum channel access procedure and has no additional messages to transmit to the UE in the one or more upcoming paging occasions.

4. The method of claim 3, wherein the short message includes a flag indicating that the network entity successfully performed the shared spectrum channel access procedure and has no additional messages to transmit to the UE in the one or more upcoming paging occasions.

5. The method of claim 3, wherein the short message is received via control signaling for paging early indication.

6. The method of claim 1, wherein receiving the indication comprises:
receiving a paging early indication including downlink control information indicating that the network entity successfully performed the shared spectrum channel access procedure and has no additional messages to transmit to the UE in the one or more upcoming paging occasions.

7. The method of claim 6, wherein the downlink control information includes a flag indicating that the network entity successfully performed the shared spectrum channel access procedure and has no additional messages to transmit to the UE in the one or more upcoming paging occasions.

8. The method of claim 1, wherein the shared spectrum channel access procedure is a clear channel assessment or a listen-before-talk procedure.

9. The method of claim 1, wherein receiving the indication comprises:
receiving a paging early indication for a subgroup of the UE or for a different subgroup than the subgroup of the UE, wherein receiving the paging early indication for the subgroup of the UE or for the different subgroup indicates that the network entity successfully performed the shared spectrum channel access procedure and has no additional messages to transmit to the UE or the subgroup of the UE in the one or more upcoming paging occasions.

10. The method of claim 1, wherein monitoring the first paging early indication occasion comprises:
monitoring the first paging early indication occasion as a relay UE for a remote UE, wherein the set of multiple paging early indication occasions are configured for the remote UE.

11. The method of claim 1, wherein monitoring the first paging early indication occasion comprises:
monitoring the first paging early indication occasion of the set of multiple paging early indication occasions on an unlicensed radio frequency spectrum band or a licensed radio frequency spectrum band.

12. A method for wireless communications at a network entity, comprising:
performing a shared spectrum channel access procedure to obtain access to a wireless channel of a shared spectrum; and
transmitting, during a first paging early indication occasion of a set of multiple paging early indication occasions, an indication that the network entity successfully performed the shared spectrum channel access procedure and has no additional messages to transmit to a user equipment (UE) in one or more upcoming paging occasions, wherein the set of multiple paging early indication occasions are configured to indicate whether the UE is to process or skip the one or more upcoming paging occasions.

13. The method of claim 12, further comprising:
transmitting a broadcast signal indicating that the network entity supports transmitting the indication, wherein transmitting the indication is based at least in part on the broadcast signal.

14. The method of claim 12, wherein transmitting the indication comprises:
transmitting a short message indicating that the network entity successfully performed the shared spectrum channel access procedure and has no additional messages to transmit to the UE in the one or more upcoming paging occasions.

15. The method of claim 14, wherein the short message includes a flag indicating that the network entity successfully performed the shared spectrum channel access procedure and has no additional messages to transmit to the UE in the one or more upcoming paging occasions.

16. The method of claim 12, wherein transmitting the indication comprises:
transmitting a paging early indication including downlink control information indicating that the network entity successfully performed the shared spectrum channel access procedure and has no additional messages to transmit to the UE in the one or more upcoming paging occasions.

17. The method of claim 16, wherein the downlink control information includes a flag indicating that the network entity successfully performed the shared spectrum channel access procedure and has no additional messages to transmit to the UE in the one or more upcoming paging occasions.

18. The method of claim 14, wherein the short message is transmitted via control signaling for paging early indication.

19. The method of claim 12, wherein the shared spectrum channel access procedure is a clear channel assessment or a listen-before-talk procedure.

20. The method of claim 12, wherein transmitting the indication comprises:
transmitting a paging early indication for a subgroup of the UE or a different subgroup than the subgroup of the UE, wherein transmitting the paging early indication for the subgroup of the UE or the different subgroup indicates that the network entity successfully performed the shared spectrum channel access procedure and has no additional messages to transmit to the UE or the subgroup of the UE in the one or more upcoming paging occasions.

21. The method of claim 12, wherein the wireless channel is on an unlicensed radio frequency spectrum band.

22. An apparatus for wireless communications at a user equipment (UE), comprising:
a processor;
memory coupled with the processor; and
instructions stored in the memory and executable by the processor to cause the apparatus to:
monitor a first paging early indication occasion of a set of multiple paging early indication occasions, wherein the set of multiple paging early indication occasions are configured to indicate whether the UE is to process or skip one or more upcoming paging occasions;
receive, based at least in part on monitoring the first paging early indication occasion, an indication that a network entity successfully performed a shared spectrum channel access procedure and has no additional messages to transmit to the UE in the one or more upcoming paging occasions; and
skip monitoring of remaining paging early indication occasions of the set of multiple paging early indication occasions based at least in part on receiving the indication.

23. The apparatus of claim 22, wherein the instructions are further executable by the processor to cause the apparatus to:
receive a broadcast signal indicating that the network entity supports transmitting the indication, wherein monitoring the first paging early indication occasion is based at least in part on the broadcast signal.

24. The apparatus of claim 22, wherein the instructions to receive the indication are executable by the processor to cause the apparatus to:
receive a short message indicating that the network entity successfully performed the shared spectrum channel access procedure and has no additional messages to transmit to the UE in the one or more upcoming paging occasions.

25. The apparatus of claim 24, wherein the short message includes a flag indicating that the network entity successfully performed the shared spectrum channel access procedure and has no additional messages to transmit to the UE in the one or more upcoming paging occasions.

26. The apparatus of claim 24, wherein:
the short message is received via control signaling for paging early indication.

27. The apparatus of claim 22, wherein the instructions to receive the indication are executable by the processor to cause the apparatus to:
receive a paging early indication including downlink control information indicating that the network entity successfully performed the shared spectrum channel access procedure and has no additional messages to transmit to the UE in the one or more upcoming paging occasions.

28. The apparatus of claim 27, wherein the downlink control information includes a flag indicating that the network entity successfully performed the shared spectrum channel access procedure and has no additional messages to transmit to the UE in the one or more upcoming paging occasions.

29. The apparatus of claim 22, wherein the instructions to receive the indication are executable by the processor to cause the apparatus to:
receive a paging early indication for a subgroup of the UE or for a different subgroup than the subgroup of the UE, wherein receiving the paging early indication for the subgroup of the UE or for the different subgroup indicates that the network entity successfully performed the shared spectrum channel access procedure and has no additional messages to transmit to the UE or the subgroup of the UE in the one or more upcoming paging occasions.

30. An apparatus for wireless communications at a network entity, comprising:
a processor;
memory coupled with the processor; and
instructions stored in the memory and executable by the processor to cause the apparatus to:
perform a shared spectrum channel access procedure to obtain access to a wireless channel of a shared spectrum; and
transmit, during a first paging early indication occasion of a set of multiple paging early indication occasions, an indication that the network entity successfully performed the shared spectrum channel access procedure and has no additional messages to transmit to a user equipment (UE) in one or more upcoming paging occasions, wherein the set of multiple paging early indication occasions are configured to indicate whether the UE is to process or skip the one or more upcoming paging occasions.
